(19) United States
(12) Patent Application Publication
(10) Pub. No.: US 2026/0335851 A1
(43) Pub. Date: Oct. 29, 2026

(54) MIXING CHAMBER FOR A GAS-SOLID CO-CURRENT DOWNFLOW FLUIDISED-BED REACTOR

(71) Applicant: IFP ENERGIES NOUVELLES, RUEIL-MALMAISON (FR)

(72) Inventors: Sina TEBIANIAN, Rueil-Malmaison Cedex (FR); Jan VERSTRAETE, Rueil-Malmaison Cedex (FR)

(73) Assignee: IFP ENERGIES NOUVELLES, RUEIL-MALMAISON (FR)

(21) Appl. No.: 19/120,611

(22) PCT Filed: Oct. 4, 2023
(86) PCT No.: PCT/EP2023/077468

§ 371 Date: Apr. 11, 2025

(30) Foreign Application Priority Data
Oct. 13, 2022 (FR) 2210520

(51) Int. Cl. B01J 8/00; B01F 23/30; B01F 25/314; B01F 25/421; B01F 25/434; B01F 101/00; B01J 8/18; B01J 8/34; C10G 11/18

(52) U.S. Cl. CPC B01J 8/003; B01F 23/36; B01F 25/3141; B01F 25/4231; B01F 25/434; B01J 8/1827; B01J 8/1881; B01J 8/34; C10G 11/18; B01F 2101/2204; B01F 2215/0422; B01F 2215/0427; B01J 2208/00752; B01J 2208/0084; B01J 2208/00902

(57) ABSTRACT

An apparatus and process for cocurrent gas-solid downflow fluid catalytic cracking comprising/using: a pipe (1) suitable for transporting a downward flow (4) of catalyst particles; a mixing chamber (2) connected to and fed by the pipe with catalyst particles and comprising an internal wall, at least one first injector (5) for injecting hydrocarbon feedstock (6) and a central plug (12) defining an annular zone (13) via which the catalyst particles pass through the mixing chamber; and a cocurrent gas-solid downflow fluidized bed reactor (3) fed by the mixing chamber with a mixture comprising catalyst particles and hydrocarbon feedstock, in which the central plug comprises at least one internal (11) arranged below the at least one first injector and being suitable for distributing the mixture towards the wall of the mixing chamber.

### TECHNICAL FIELD

The invention relates to the field of refining and petrochemistry and processes and units for the chemical transformation of petroleum products, especially hydrocarbon cuts, by fluid catalytic cracking (FCC) for the production of light olefins (i.e. olefins comprising between 2 and 4 carbon atoms), and more particularly ethylene and propylene, and also aromatics (e.g. BTX), and more particularly para-xylene.

### PRIOR ART

The invention resides in improving the design of the established flow zone in cocurrent gas-solid downflow fluidized bed reactors (“downers” or “downflow reactors”), referred to hereinafter as downflow reactors, used for example for high severity catalytic cracking (HS-FCC).

Ethylene, propylene, butene, butadiene and aromatics such as benzene, toluene and xylene (BTX) represent the base products for the petrochemicals industry. These products are generally obtained by catalytic reforming and/or thermal cracking (steam cracking) of hydrocarbons such as naphtha, kerosene or gas oil. These compounds are also obtained by fluid catalytic cracking (FCC) of hydrocarbons, such as a vacuum distillate (VD, or VGO for vacuum gas oil) and/or a (vacuum or atmospheric) residue from the distillation of hydrocarbons and/or naphtha, gas oils, and whole crudes.

The high severity catalytic cracking (HS-FCC) process is aimed at increasing the yields of propylene and ethylene via high-temperature reaction conditions, very short contact times (e.g. ~1 s), and high ratios between the mass flow rate C of catalyst and the mass flow rate O of feedstock (C/O).

The disadvantages associated with a conventional cocurrent gas-solid upflow fluidized bed FCC reactor (or “riser”), such as backmixing and the accumulation of catalyst in the vicinity of the wall resulting in overcracking of the hydrocarbons and excessive formation of coke, hydrogen, methane and ethane, do not make it possible to promote the production of olefins under high severity conditions.

In order to overcome these disadvantages, the HS-FCC process uses a downflow reactor, in which the catalyst and the feedstock are set in motion under the effect of gravity with a flow that approximates that of plug flow. The downward gas-solid flow in a reactor avoids the backmixing and overcracking of the products, while the use of high C/O ratios ensures the predominance of the catalytic reactions. The high temperature promotes the formation of reaction intermediates such as light olefins, while a controlled and short contact time avoids the side reactions that are responsible for the consumption of such intermediates.

On the other hand, the downward gas-solid flow exhibits a number of major technological challenges, of which one significant challenge corresponds to the flow within the mixing chamber. This is because the initial mixing between the catalyst and the feedstock determines the vaporization of the hydrocarbons and the gas-solid contact throughout the downflow reactor. The initial mixing is generally performed in a fraction of a second with, for a typical HS-FCC, a flow rate of the order of 400 to 700 t/h of feedstock and 7000 to 21 000 t/h of catalyst, which requires efficient technology in order to have a mixing chamber that approximates a perfectly stirred zone.

Patent FR 2 753 453 B1 describes a downflow cracking reactor comprising a zone for bringing into contact the hydrocarbons and the catalyst and consisting of: a mixing chamber with a maximum cross section S2, which is placed in communication with means for feeding regenerated catalyst via an upper orifice defining a cross section for passage of the catalyst S1, and a reaction zone with a maximum cross section S4, which is placed in communication with the mixing chamber via an intermediate orifice with a cross section S3, in which reactor the ratios S2/S1 and S2/S3 are between 1.5 and 8. Patent FR 2 753 453 B1 also describes a plug arranged at the lower end of the catalyst pipe feeding the mixing chamber, the plug defining an upper annular orifice of the mixing chamber.

Patent application US 2022/0016589 A1 describes a downflow reactor the feed zone of which comprises an elongate plug on which helical vanes are positioned.

Patents U.S. Pat. No. 10,889,768 B2 and U.S. Pat. No. 10,767,117 B2 describe systems and processes for producing petrochemical products (e.g. ethylene and other olefins) from hydrocarbon feedstocks (e.g. crude oil) in high severity fluid catalytic cracking (HS-FCC) units.

### SUMMARY OF THE INVENTION

Within the above-described context, a first objective of the present invention is to overcome the problems of the prior art and to provide an apparatus for cocurrent gas-solid downflow fluid catalytic cracking with homogeneous catalyst flow, i.e. in which the concentration of solid in the cross section of the reactor is substantially uniform. Specifically, the apparatus according to the invention makes it possible to achieve improved catalyst dispersion between the central zone and the annular zone (i.e. in the vicinity of the wall) of the cocurrent gas-solid downflow reactor.

According to a first aspect, the abovementioned objectives, along with other advantages, are achieved by an apparatus for cocurrent gas-solid downflow fluid catalytic cracking comprising, from top to bottom:
a pipe suitable for transporting a downward flow of catalyst particles;
a mixing chamber connected to the pipe and suitable for being fed by the pipe with downward flow, the mixing chamber comprising an internal wall, at least one first injector for injecting hydrocarbon feedstock and a central plug defining an annular zone via which the catalyst particles pass through the mixing chamber; and
a cocurrent gas-solid downflow fluidized bed reactor connected to the mixing chamber and suitable for being fed by the mixing chamber with a mixture comprising catalyst particles and hydrocarbon feedstock,
   in which apparatus the mixing chamber comprises at least one internal (e.g. obstacle, deflector) arranged on and preferably around the central plug and arranged below the at least one first injector and being suitable for distributing the mixture towards the wall of the mixing chamber.

Advantageously, the internal makes it possible to homogenize the concentration of catalyst particles.

According to one or more embodiments, the at least one internal is suitable for reducing the passage cross section in the annular zone by 1% to 35%.

According to one or more embodiments, the at least one internal is suitable for avoiding the accumulation of catalyst particles on said internal.

According to one or more embodiments, the at least one internal is suitable comprises an oblique upper surface that descends towards the outside.

According to one or more embodiments, the oblique upper surface of the at least one internal is straight, convex and/or concave.

According to one or more embodiments, the oblique upper surface of the at least one internal forms an angle β comprised between 10° and 80°, relative to the horizontal.

According to one or more embodiments, the at least one internal is arranged on the central plug at an axial distance from the first injectors for injecting hydrocarbon feedstock of between 0*H3 and 1*H3, H3 being the height of the at least one internal.

According to one or more embodiments, the at least one internal is a plurality of internals positioned discontinuously on the central plug.

According to one or more embodiments, the internals are prismatic, cylindrical, pyramidal, conical and/or frustoconical in form.

According to one or more embodiments, the apparatus comprises at least one row of internals arranged at a predetermined height on the central plug.

According to one or more embodiments, the perimeter of the wall of the central plug occupied by the row of internals is between 10% and 100%.

According to one or more embodiments, the row of internals comprises between 1 and 16 internals.

According to one or more embodiments, the at least one internal is annular in form and is positioned continuously on and around the central plug.

According to one or more embodiments, the apparatus comprises between 1 and 6 rows of discontinuous internals and/or between 1 and 12 internals of annular form arranged at a predetermined height on the central plug.

According to a second aspect, the abovementioned objectives, along with other advantages, are achieved by a process for cocurrent gas-solid downflow fluid catalytic cracking, comprising the following steps:
transporting a downward flow of catalyst particles in a pipe;
feeding a mixing chamber via the pipe with the downward flow, the mixing chamber comprising an internal wall, at least one first injector for injecting hydrocarbon feedstock and a central plug defining an annular zone via which the catalyst particles pass through the mixing chamber;
feeding a cocurrent gas-solid downflow fluidized bed reactor via the mixing chamber with a mixture comprising catalyst particles and hydrocarbon feedstock; and
at least partially cracking the hydrocarbon feedstock in the presence of the catalyst particles in the cocurrent gas-solid downflow fluidized bed reactor, in order to produce an effluent comprising at least partially coked catalyst and gaseous cracking products,
in which the mixing chamber comprises at least one internal arranged below the at least one first injector and being suitable for distributing the mixture towards the wall of the mixing chamber.

Other features and advantages of the invention of the aforementioned aspects will become apparent on reading the following description of non-limiting exemplary embodiments, with reference to the appended figures described below.

### LIST OF THE FIGURES

FIG. 1 represents an FCC apparatus according to one or more embodiments of the present invention, comprising a central plug provided with internals for homogenization of the catalyst flow.

FIG. 2 shows a view from above of an FCC apparatus according to one or more embodiments of the present invention, comprising a frustoconical mixing chamber provided with an internal arranged continuously around the central plug.

FIG. 3 shows a view from above of an FCC apparatus according to one or more embodiments of the present invention, comprising a frustoconical mixing chamber provided with internals arranged discontinuously around the central plug.

FIG. 4 shows a 3D view of an FCC apparatus according to one or more embodiments of the present invention, comprising an internal arranged continuously around the central plug and a plurality of obstacles on the wall of the mixing chamber.

FIG. 5 shows cross-sectional views of the mass fraction of the catalyst in an FCC apparatus according to the invention A as represented in FIG. 4, and in a reference FCC apparatus B.

### DETAILED DESCRIPTION OF THE INVENTION

Embodiments according to the aforementioned aspects will now be described in detail. The following detailed description discloses numerous specific details in order to provide a deeper understanding of the apparatus and process according to the present invention. However, it will be apparent to those skilled in the art that the apparatus can be implemented without these specific details. In other cases, well-known features have not been described in detail in order to avoid unnecessarily complicating the description.

In the present description, the term “comprise” is synonymous with (means the same thing as) “have”, “include” and “contain”, and is inclusive or open-ended and does not exclude other elements that are not stated. It is understood that the term “to comprise” includes the exclusive and closed term “to consist of”. In addition, in the present description, the terms “essentially” or “substantially” or “approximately” correspond to an approximation of ±10%, preferably of ±5%, very preferably of ±1%.

The invention relates to an apparatus and to a process for fluid catalytic cracking for the chemical transformation of petroleum products (FCC), used for example for high severity catalytic cracking (HS-FCC).

An FCC unit generally treats a heavy cut obtained from the vacuum distillation unit, such as a vacuum gas oil or a vacuum residue, or else an atmospheric residue, alone or as a mixture.

An FCC unit can also treat lighter cuts such as a gasoline cut or a gas oil cut, alone or as a mixture. It is also possible to treat a mixture of light and heavy cuts, or else a whole crude. In order to increase the propylene and ethylene yields by using high severity reaction conditions (high temperature, very short contact time, high C/O ratios between the flow rate C of catalyst and the flow rate O of feedstock), the catalytic cracking apparatuses and processes generally use a cocurrent gas-solid downflow fluidized bed reactor (“downer” or “downflow reactor”), hereinafter referred to as a downflow reactor.

However, the downward gas-solid flow may exhibit a number of technological challenges, including achieving homogeneous flow and mixing in the established flow section of the downflow reactor.

In order to overcome these disadvantages, improvements to the downflow reactor technology described in the patent FR 2 753 453 B1 have been identified in order to respond to the challenge set out above, by way of a specific arrangement of hydrocarbon feedstock injectors, and optionally diluent injectors, to improve the contact between the catalyst and the hydrocarbons in the mixing chamber.

### The Apparatus According to the Invention

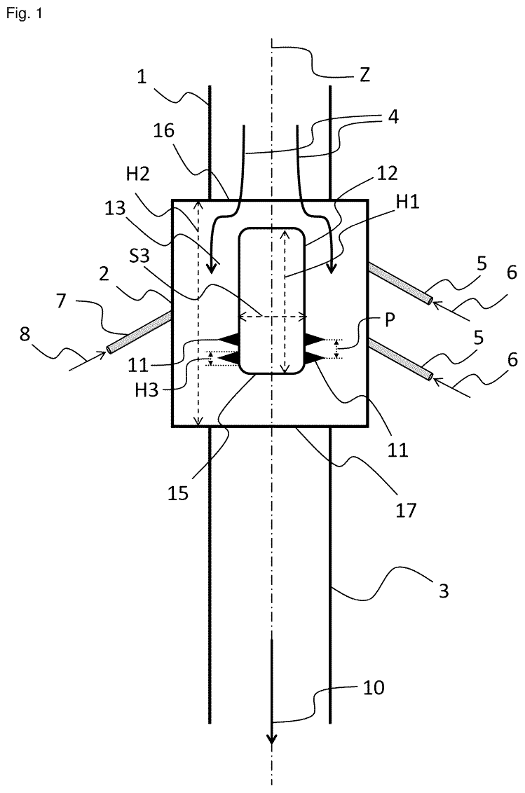

With reference to FIG. 1, the apparatus for cocurrent gas-solid downflow fluid catalytic cracking comprises, from top to bottom:
a (substantially vertical) pipe 1;
a mixing chamber 2; and
a (substantially vertical) downflow reactor 3.

The pipe 1 is suitable for feeding the mixing chamber 2 with solid catalyst (particles). The pipe 1 mainly transports solid, and also a fluidizing gas entrained by the downward flowing solid. The pipe 1 exhibits a flow like a standpipe well known to those skilled in the art.

The mixing chamber 2 is connected to the pipe 1, comprises a side/vertical wall defining a central/vertical axis Z, and is suitable for feeding the downflow reactor 3 with a mixture comprising catalyst particles, a hydrocarbon feedstock and optionally a diluent.

The downflow reactor 3 is connected to the mixing chamber 2 and is suitable for at least partially cracking the hydrocarbon feedstock in the presence of the catalyst particles in order to produce an effluent comprising at least partially coked catalyst and gaseous cracking products, and optionally unconverted vaporized feedstock.

Specifically, with reference to FIG. 1, the pipe 1 feeds the mixing chamber 2 with a downward flow 4 of (hot) catalyst particles, the mixing chamber 2 comprising a plurality of first injectors 5 for injecting hydrocarbon feedstock 6. According to one or more embodiments, the first injector(s) 5 is/are suitable for injecting diluent (e.g. steam) with the feedstock. According to one or more embodiments, the mixing chamber 2 comprises one or more second injectors 7 for injecting diluent 8. In the mixing chamber 2, the downward flow 4 comes into contact with the hydrocarbon feedstock 6 atomized by means of the first injector(s) 5 and optionally with diluent 8 introduced for example by the second injector(s) 7.

Advantageously, the injection of diluent 8 makes it possible to reduce the partial pressure of the hydrocarbon feedstock and to reduce side reactions. Advantageously, the injection of diluent 8 makes it possible to improve the atomization of the hydrocarbon feedstock 6.

According to one or more embodiments, the diluent 8 is chosen from the group consisting of steam, nitrogen, CO₂, light hydrocarbons (e.g. C1-C5 compounds) and combustion flue gases. According to one or more embodiments, the diluent 8 comprises or consists of steam.

According to one or more embodiments, the pipe 1 has a geometry with a constant cross section, such as cylindrical, square, rectangular or hexagonal, or with a variable cross section, such as truncated pyramidal or frustoconical, or a combination of the various geometrical forms. According to one or more embodiments, the pipe 1 is cylindrical in form and optionally of variable diameter. According to one or more embodiments, the pipe 1 is at least partially frustoconical in form. According to one or more embodiments, the pipe 1 comprises (in the direction of flow of the solid catalyst): a cylindrical portion, the diameter of which is for example chosen in order to obtain a flow of solid of 100 to 800 kg/(m²s) and preferably between 300 to 600 kg/(m²s); a frustoconical (“narrowing”) portion adjacent to the mixing chamber 2, the diameter of which decreases, for example in order to achieve a flow of solid, without taking the internals into account, of between 400 and 2000 kg/(m²s) and preferably between 700 and 1500 kg/(m²s); and optionally a second cylindrical portion, the diameter of which is for example chosen in order to obtain a flow of solid, without taking the internals into account, of between 400 and 2000 kg/(m²s) and preferably between 700 and 1500 kg/(m²s).

According to one or more embodiments, the mixing chamber 2 has a geometry with a constant cross section, such as cylindrical, square, rectangular or hexagonal, or with a variable cross section, such as truncated pyramidal or frustoconical, or a combination of the various geometrical forms. According to one or more embodiments, the mixing chamber 2 is cylindrical in form and optionally of variable diameter. According to one or more embodiments, the mixing chamber 2 is at least partially frustoconical in form. According to one or more embodiments, the mixing chamber 2 comprises an upper cross-sectional boundary S1 connecting the mixing chamber 2 to the pipe 1 and a lower cross-sectional boundary S2 connecting the mixing chamber 2 to the downflow reactor 3, the ratio S1/S2 being less than 0.9 and preferably less than 0.7. According to one or more embodiments, the ratio S1/S2 is between 0.4 and 0.9, preferably between 0.5 and 0.7.

According to one or more embodiments, the mixing chamber 2 comprises between 2 and 12 first injectors 5, preferably between 3 and 8 first injectors 5.

According to one or more embodiments, the mixing chamber 2 comprises between 2 and 12 second injectors 7, preferably between 3 and 8 second injectors 7.

According to one or more embodiments, the injectors 5 and/or 7 are inclined upwards or downwards or are arranged substantially horizontally.

According to one or more embodiments, the injectors 5 and/or 7 are inclined upwards, for example with an angle of between 10° and 45° relative to the horizontal.

With reference to FIG. 1, according to one or more embodiments, first injectors 5 and/or second injectors 7 are arranged in one or more horizontal rows, i.e. perpendicularly to the central/vertical axis Z of the mixing chamber 2. According to one or more embodiments, second injectors 7 are arranged below (for example, a row of) first injectors 5. According to one or more embodiments, second injectors 7 are arranged between two rows of first injectors 5.

According to one or more embodiments, the radial position of the second injectors 7 is in a separating space between the adjacent radial positions of two first injectors 5. According to one or more embodiments, the second injectors 7 are positioned substantially at half the angle of separation of two first injectors 5.

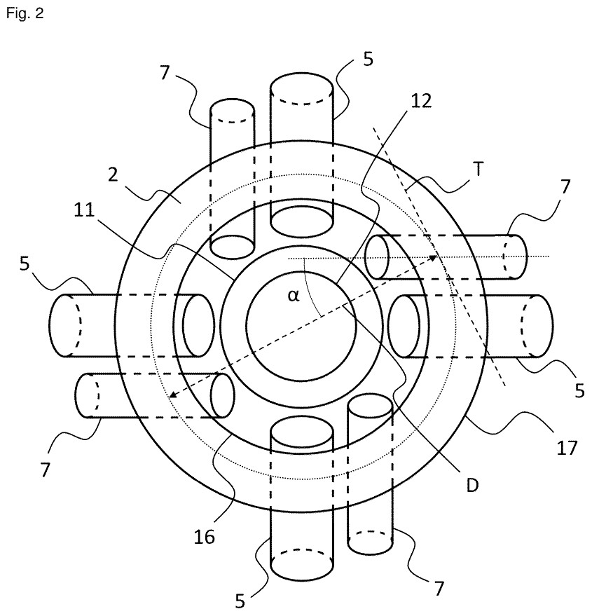

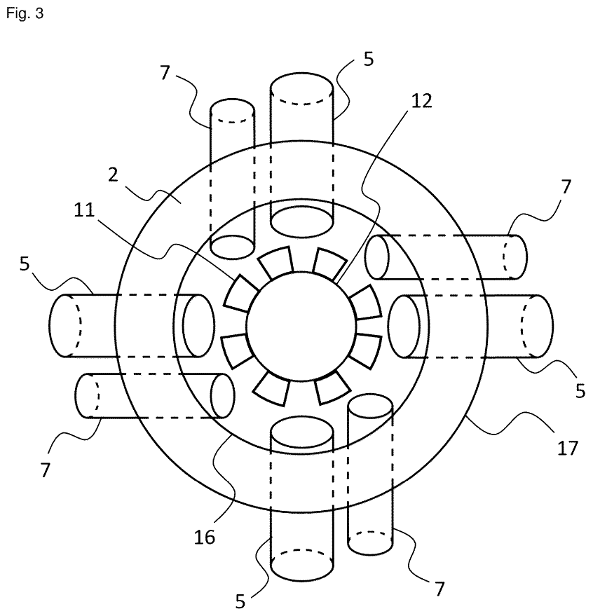

With reference to FIGS. 2 and 3, according to one or more embodiments, at least one first injector 5 and/or at least one second injector 7 is rotated by an angle α of between 0° and 45°, and preferably of between 10° and 20°, relative to the radial direction of the diameter D of the mixing chamber 2, i.e., the projection of the axis of the injectors 7 on a horizontal plane forms an angle α, with the radial direction of the diameter D of the mixing chamber 2, which is perpendicular to the central/vertical axis Z.

With reference to FIG. 1, the mixing chamber 2 feeds the downflow reactor 3 with a mixture of hydrocarbon feedstock 6, catalyst particles and optionally diluent 8. Advantageously, the hydrocarbon feedstock 6 and the catalyst particles give rise to cracking reactions which are completed in the downflow reactor 3 of length L (along the central/vertical axis Z) to produce a hydrocarbon effluent comprising cracking products, spent catalyst and potentially a portion of the hydrocarbon feedstock that has not reacted.

According to one or more embodiments, the downflow reactor 3 has a geometry with a constant cross section, such as cylindrical, square, rectangular or hexagonal, and preferably cylindrical.

According to one or more embodiments, the downflow reactor 3 is cylindrical in form and optionally of variable diameter. According to one or more embodiments, the diameter of the downflow reactor 3 is defined such that the superficial velocity of the gas passing through it is between 2 m/s and 26 m/s, preferentially between 6 m/s and 16 m/s.

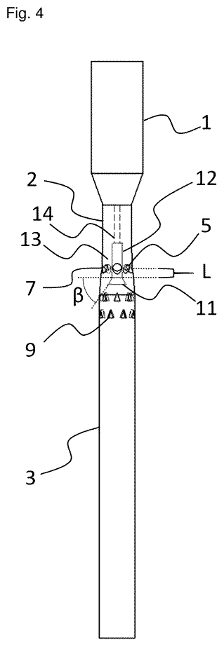

With reference to FIG. 4, according to one or more embodiments, the internal wall of the mixing chamber 2 and/or of the downflow reactor 3 additionally comprises a plurality of obstacles 9. Advantageously, the plurality of obstacles 9 is suitable for homogenizing the concentration of catalyst particles. Specifically, the obstacles 9 make it possible to redistribute the catalyst particles which may accumulate close to the walls (e.g. of the mixing chamber 2 and the downflow reactor 3).

The obstacles 9 may be of varied geometrical forms. According to one or more embodiments, the obstacles 9 are prismatic (e.g. prism with a triangular, square, rectangular, hexagonal, circular or elliptical base), or pyramidal (e.g. pyramid with a triangular, square, rectangular, hexagonal, circular or elliptical base), or frustoconical in form, the obstacles 9 being positioned discontinuously, forming for example separate elements on the wall of the mixing chamber 2.

With reference to FIG. 4, according to one or more embodiments, the apparatus according to the invention comprises at least one row of obstacles 9, relative to the central/vertical axis Z, arranged at a predetermined height of the internal wall of the mixing chamber 2 and/or of the downflow reactor 3. According to one or more embodiments, the obstacles 9 of the row of obstacles 9, thus arranged in a “string of beads”, are positioned substantially equidistantly from one another. Advantageously, a row of obstacles 9 comprises (all) the obstacles 9 of a (horizontal) plane perpendicular to the central/vertical axis Z.

According to one or more embodiments, the obstacles 9 comprise a lower part (lower end surface) that is wider than the upper part (upper end surface).

According to one or more embodiments, the obstacles 9 are arranged to distribute the catalyst particles towards feedstock injection zones of the mixing chamber 2, zones which are more concentrated in hydrocarbons. According to one or more embodiments, the obstacles 9 comprise an oblique upper surface that descends laterally, i.e. along the wall of the mixing chamber 2.

According to one or more embodiments, the obstacles 9 are arranged to distribute the catalyst particles substantially towards the inside (e.g. towards the central/vertical axis Z), a zone which is more concentrated in hydrocarbons. According to one or more embodiments, the obstacles 9 comprise an oblique upper surface that descends from the outside towards the inside.

According to one or more embodiments, obstacles 9 are arranged in the mixing chamber 2 upstream of the at least one first injector 5 for injecting hydrocarbon feedstock 6 and/or of the at least one second injector 7 for injecting diluent 8.

Advantageously, the obstacles 9 make it possible to direct the catalyst particles towards the injectors and increase the contact, in particular with the hydrocarbon feedstock 6. According to one or more embodiments, the radial position of the obstacles 9 in the mixing chamber 2 is in a separating space between the adjacent radial positions of two (e.g. first) injectors.

With reference to FIGS. 1 to 4, according to the invention, at least part of the mixing chamber comprises a central plug 12 arranged substantially along the central/vertical axis Z and defining an annular zone 13 in the mixing chamber 2, via which the catalyst particles discharge and/or flow into the mixing chamber 2.

According to one or more embodiments, the central plug 12 covers the axial position of the first injectors 5. According to one or more embodiments, the central plug 12 covers the axial position of the first injectors 5 and of the second injectors 7. Advantageously, the central plug 12 makes it possible to improve the initial contact between the catalyst particles of the downward flow 4 and the hydrocarbon feedstock 6, and to improve the dispersion of the catalyst/feedstock mixture.

According to one or more embodiments, the central plug 12 has a geometry with a constant cross section, such as cylindrical, square, rectangular or hexagonal, or with a variable cross section, such as truncated pyramidal or frustoconical, or a combination of the various geometrical forms. According to one or more embodiments, the central plug 12 has a cylindrical, square, rectangular or hexagonal, preferably cylindrical, cross section, relative to the central/vertical axis Z, which cross section is preferably axisymmetrical relative to the mixing chamber 2. According to one or more embodiments, the central plug 12 is circular cylindrical in form. According to one or more embodiments, the central plug 12 is cylindrical in form and optionally of variable diameter. According to one or more embodiments, the central plug 12 is at least partially frustoconical in form. According to one or more embodiments, the central plug 12 comprises a first cylindrical section, a frustoconical section and a second cylindrical section.

According to one or more embodiments, the central plug 12 is suitable for reducing the passage cross section in the mixing chamber 2 by 1% to 50% and preferably by 3% to 15% (e.g. between 6% and 12%), preferably at an axial position covering the axial position of the first injectors 5.

According to one or more embodiments, the central plug 12 comprises a lower part of section S3 and an upper part 14 of section S4, S3 being greater than S4. According to one or more embodiments, the central plug 12 comprises, from top to bottom, a first cylindrical section, for example section S4, a frustoconical section, for example from section S4 to S3, and a second cylindrical section, for example section S3, S3 being greater than S4.

According to one or more embodiments, the central plug 12 extends from the pipe 1 to the mixing chamber 2. Preferably, the central plug 12 extends from the pipe 1, passes through the mixing chamber 2, and ends in the downflow reactor 3.

According to one or more embodiments, the part of the central plug 12 that is positioned in the mixing chamber 2 has a height H1 of between 10% and 100% of the height H2 of the mixing chamber 2. According to one or more embodiments, the lower end 15 of the central plug 12 is below the axial position of the lowest injectors (5, 7) and/or the upper end 16 of the central plug 12 is above the axial position of the highest injectors (5, 7).

According to one or more embodiments, the lower end 15 of the central plug 12 is at an axial position arranged below the axial position of the lowest injectors (5, 7), it being possible for the lower end 15 to be extended up to the lower end of the mixing chamber 2 or into the downflow reactor 3. According to one or more embodiments, the upper end 16 of the central plug 12 is at an axial position arranged above the axial position of the highest injectors (5, 7), it being possible for the upper end 16 to be extended up to the upper end of the mixing chamber 2 or into the pipe 1.

The applicant has identified that inefficient penetration of the hydrocarbon feedstock 6 into the downward flow 4 of catalyst particles may result in a portion of the catalyst which does not mix with the hydrocarbon feedstock and continues to descend along the walls of the central plug 12. The flow of solid particles descending around the walls of the central plug 12 may result in a high concentration of solid in the central zone of the downflow reactor 3, which is detrimental to the contact with the hydrocarbon feedstock 6 for the catalytic reaction.

Advantageously, the applicant has identified that the use of a central plug 12 with a specific form, by way of the addition of one or more internals 11, makes it possible to redirect the catalyst away from the walls of the central plug 12 and subsequently promotes contact between the two phases.

With reference to FIGS. 1 to 4, the at least one internal (11) is arranged on the central plug (12), and preferably around the central plug (12), and is arranged at a height (along the central/vertical axis Z) below the at least one first injector (5). Advantageously, the at least one internal 11 is suitable for homogenizing the concentration of catalyst particles in the annular zone 13 of the mixing chamber 2. Specifically, the internal(s) 11 make it possible to distribute, towards the internal wall of the mixing chamber 2, catalyst particles which may accumulate close to the wall of the central plug 12. Advantageously, the internals 11 make it possible to distribute the catalyst particles substantially towards the outside (e.g. away from the central/vertical axis Z), a zone which is more concentrated in hydrocarbons.

With reference for example to FIG. 2, according to one or more embodiments, the internal 11 is annular in form and is positioned continuously (e.g. in the form of a collar) around the central plug 12, i.e. axisymmetrically relative to the central plug 12.

According to one or more embodiments, the internal 11 that is positioned continuously has a cross section (along a vertical section along the central/vertical axis Z) in the form of a triangle, square, rectangle, diamond, parallelogram, trapezoid, polygon, semicircle, sector, circular segment, elliptical segment, or parabolic segment, inter alia. According to one or more embodiments, the cross section of the continuous internal 11 is triangular in form, for example comprising a substantially horizontal lower side (right-angled triangle), as shown in FIG. 4.

According to one or more embodiments, the internals 11 that are positioned discontinuously on the central plug are cubic, tetrahedral, parallelepipedal, prismatic (e.g. prism with a triangular, square, rectangular, hexagonal, circular or elliptical base), or pyramidal (e.g. pyramid with a triangular, square, rectangular, hexagonal, circular or elliptical base), or frustoconical in form, and, forming separate elements around the central plug 12. According to one or more embodiments, the internals 11 that are positioned discontinuously on the central plug have a cross section (along a vertical section along the central/vertical axis Z) in the form of a triangle, square, rectangle, diamond, parallelogram, trapezoid, polygon, semicircle, sector, circular segment, elliptical segment, or parabolic segment, inter alia. According to one or more embodiments, the cross section of the discontinuous internals 11 is triangular in form, for example comprising a substantially horizontal lower side (right-angled triangle).

With reference to FIG. 2, according to one or more embodiments, the internal 11 that is positioned continuously has a cross section (along a horizontal section perpendicular to the central/vertical axis Z) in the form of a ring around the central plug 12.

With reference for example to FIG. 3, according to one or more embodiments, the internals 11 that are positioned discontinuously have a cross section (along a horizontal section perpendicular to the central/vertical axis Z) in the form of a cylindrical ring portion (e.g. in the form of a collar portion) around the central plug 12.

According to one or more embodiments, the internal(s) 11 are arranged to avoid the accumulation of catalyst particles on the internals 11. According to one or more embodiments, the internals 11 comprise a lower part (lower end surface) that is wider than the upper part (upper end surface). According to one or more embodiments, the internal(s) 11 comprise an oblique upper surface that descends laterally (towards the outside), i.e. along the wall of the central plug 12. According to one or more embodiments, the oblique upper surface of the internal(s) 11 is straight, convex and/or concave. According to one or more embodiments, the oblique upper surface of the internal(s) 11 forms an angle β of between 10° and 80°, preferably of between 30° and 70°, such as substantially 60°, relative to the horizontal, as shown in FIG. 4.

According to one or more embodiments, the at least one internal 11 is arranged on the central plug 12 downstream of the at least one first injector 5 for injecting hydrocarbon feedstock 6 and optionally of the at least one second injector 7 for injecting diluent 8. Advantageously, the internal(s) 11 make it possible to direct the catalyst particles towards the wall of the mixing chamber 2 below the injectors in order to increase the contact with the hydrocarbon feedstock 6. According to one or more embodiments, the radial position of the internals 11 on the central plug 12 is in a separating space between the adjacent radial positions of two (e.g. first) injectors.

According to one or more embodiments, the internal(s) 11 are arranged on the central plug 12 below the first injectors 5 for injecting hydrocarbon feedstock 6, and optionally the second injectors 7, at an axial distance L (upper end of the internal(s)) from said injectors of between 0*H1 and H1, and preferably between 0.1*H1 and 0.9*H1.

According to one or more embodiments, the annular continuous internals 11 or the rows of discontinuous internals 11 have a height H3 of between 0.02*H1 and 0.5*H1, preferably between 0.05*H1 and 0.3*H1, very preferably between 0.1*H1 and 0.2*H1.

With reference to FIG. 3, according to one or more embodiments, the apparatus according to the invention comprises at least one row of internals 11, relative to the central/vertical axis Z, arranged at a predetermined height on the central plug 12. According to one or more embodiments, the internals of the row of internals 11, thus arranged in a “string of beads”, are positioned substantially equidistantly from one another. Advantageously, a row of internals 11 comprises (all) the internals 11 of a (horizontal) plane perpendicular to the central/vertical axis Z.

According to one or more embodiments, the perimeter of the internal wall of the central plug 12 occupied by the row of internals 11 is between 10% and 100% and preferably between 30% and 100%, such as from 60% to 100%.

According to one or more embodiments, the annular continuous internal 11 or the row of discontinuous internals 11 is suitable for reducing the passage cross section in the annular zone 13 by 1% to 50% and preferably by 5% to 35%, such as by 10% to 20%, relative to the passage cross section of the annular zone 13 devoid of internals 11.

According to one or more embodiments, a row of internals 11 comprises at least 1 internal 11, for example between 2 and 16 internals 11, preferably between 3 and 8 internals 11.

According to one or more embodiments, the central plug 12 comprises between 1 and 12 annular internals 11, such as 1 annular internal 11.

According to one or more embodiments, the central plug 12 comprises between 1 and 6 rows of internals 11, such as 2 rows of internals 11, preferably arranged below the (e.g. first) injectors.

According to one or more embodiments, the radial position of the internals 11 of a row of internals 11 is in a separating space between the radial position of two adjacent internals 11 of an adjacent row of internals 11, i.e. each row of internals 11 has been rotated (about the central/vertical axis Z) relative to an adjacent row of internals 11. According to one or more embodiments, the radial position of the internals 11 of a row of internals 11 has been rotated through an angle of between 10° and 35°, preferably between 15° and 30°, relative to the radial position of the internals 11 of an adjacent row of internals 11, and preferably through an angle of 180°/N, with N the number of internals in a row of internals 11. According to one or more embodiments, the rows of internals 11 are arranged with respect to one another so as to together cover all of the perimeter of the central plug 12 when viewed along the central/vertical axis Z.

With reference to FIG. 1, according to one or more embodiments, the annular internals 11 or the rows of discontinuous internals 11 are positioned at axial positions with a distance (pitch) P from one another of between 0% and 75%, and preferably between 1% and 10%, of the height H2 of the mixing chamber 2. According to one or more embodiments, the distance (pitch) P separating the axial position of two adjacent internals 11 or adjacent rows of internals 11 is between 0*H2 and 0.75*H2, preferably between 0.01*H2 and 0.25*H2, very preferably between 0.01*H2 and 0.1*H2.

### The Catalyst

The catalyst is a solid catalyst (e.g. particles with a density, size and shape of the grains chosen for use in a fluidized bed). The densities, sizes and shapes of the catalysts for fluidized beds are known to a person skilled in the art and will not be described further. The catalyst may be any type of catalytic cracking catalyst.

According to one or more embodiments, the catalyst is an FCC catalyst, containing, for example, what is commonly called a matrix made of clay, of silica or of silica-alumina, optionally of binder, and/or of zeolite, for example from 15% to 70% by weight of zeolite relative to the weight of the catalyst, preferably a zeolite Y and/or a zeolite ZSM-5. According to one or more embodiments, the catalyst comprises a zeolite ZSM-5. According to one or more embodiments, the grain density of the catalyst is between 1000 kg/m³ and 2000 kg/m³.

According to one or more embodiments, the grain density of the catalyst is between 1250 kg/m³ and 1750 kg/m³.

According to one or more embodiments, the catalyst comprises at least one binder (e.g. from 30% to 85% by weight) chosen from alumina, silica, silica-alumina, magnesia, titanium oxide, zirconia, clays and boron oxide, alone or in a mixture, and preferably from silica, silica-alumina and clays, alone or in a mixture.

According to one or more embodiments, the catalyst comprises at least one doping element (e.g. from 0 to 10% by weight) chosen from phosphorus, magnesium, sodium, potassium, calcium, iron, boron, manganese, lanthanum, cerium, titanium, tungsten, molybdenum, copper, zirconium and gallium, alone or in a mixture.

According to one or more embodiments, the catalyst comprises and/or consists of zeolite, such as ZSM-5, which is optionally doped.

### The Feedstock

According to one or more embodiments, the hydrocarbon feedstock 6 is a heavy feedstock, characterized by an initial boiling point close to 340 °C, often above 380 °C, such as a heavy cut, for example obtained from a vacuum distillation unit, such as vacuum gas oil (VGO)/vacuum distillate or a vacuum residue, an atmospheric residue, vacuum gas oil obtained from a conversion unit, such as a coker gas oil (heavy coker gas oil (HCGO)) or a heavy cut obtained from an ebullated bed or entrained bed hydroconversion unit (such as H-Oil, LC-Fining, EST, VCC or Uniflex processes), a recycle stream from a hydrocracking step, alone or as a mixture.

According to one or more embodiments, the hydrocarbon feedstock 6 is a light feedstock, characterized by a final boiling point below 450 °C, often below 400 °C, such as a gasoline cut or a gas oil cut, for example obtained from an atmospheric distillation unit, or obtained from a conversion unit, such as a gasoline or a gas oil from a hydrocracking unit, or a gasoline or a gas oil from a coking unit or a gasoline or a gas oil from an ebullated bed or entrained bed hydroconversion unit (such as H-Oil, LC-Fining, EST, VCC or Uniflex processes), or a gasoline or a gas oil obtained from an FCC unit, or a recycle stream from the FCC unit concerned, alone or as a mixture. According to one or more embodiments, it is also possible to treat a mixture of light and heavy cuts, or else a whole crude.

On contact with the downward flow 4 of hot catalyst particles, the sprayed hydrocarbon feedstock 6 vaporizes and endothermic cracking reactions take place along the downflow reactor 3, thus reducing the temperature and producing:
upgradable products (e.g. C1-C4 gas comprising olefins; a gasoline cut comprising aromatics);
optionally a light gas oil cut (light cycle oil (LCO));
optionally a heavy gas oil cut (heavy cycle oil (HCO));
optionally an oil in the form of slurry; and
optionally a solid residue (coke) adsorbed on the catalyst.

### The Process According to the Invention

The process according to the present invention comprises a catalytic cracking step for producing light olefins (and in particular ethylene and propylene), aromatics (and in particular benzene, toluene and xylenes), and gasoline (and optionally LCO, HCO and slurry), by catalytic cracking the hydrocarbon feedstock 6 (fed by the first injector 5) by contacting with the downward flow 4 of hot catalyst particles (fed by pipe 1), and optionally diluent 8 (fed by the second injector 7), in the mixing chamber 2 and then in the downflow reactor 3.

According to one or more embodiments, the downward flow 4 of the catalyst particles in the pipe 1 upstream of the mixing chamber 2 is in dense fluidized regime, preferably with a mass flow greater than 200 kg/m²s, in order for example to preferably enable a regime with descending bubbles.

In the present patent application, the term “dense fluidized bed” means a gas-solid fluidized bed operating in homogeneous regime, in ebullating regime or in turbulent regime.

In the present patent application, the term “homogeneous fluidized bed” means a gas-solid fluidized bed, the gas velocity of which is between the minimum fluidization velocity and the minimum ebullition velocity. These velocities depend on the properties of the solid catalyst (density, size, shape of the grains, etc.). The volume fraction of solid is between a value close to 0.45 and the maximum volume fraction of solid corresponding to a non-fluidized fixed bed, generally close to 0.6.

In the present patent application, the term “ebullating fluidized bed” means a gas-solid fluidized bed, the gas velocity of which is between the minimum ebullition velocity and the velocity of transition to the turbulent regime. These velocities depend on the properties of the solid catalyst (density, size, shape of the grains, etc.). The volume fraction of solid is between a value close to 0.35 and a value close to 0.45.

In the present patent application, the term “turbulent fluidized bed” means a gas-solid fluidized bed, the gas velocity of which is between the velocity of transition to the turbulent regime and the transport velocity. The volume fraction of solid is between a value close to 0.25 and a value close to 0.35.

In the present patent application, the term “transport fluidized bed” means a gas-solid fluidized bed, the gas velocity of which is greater than the transport velocity. The volume fraction of solid is less than a value close to 0.25. In the present patent application, the term “transport velocity” corresponds to the velocity with which essentially all the solid is entrained by the gas.

According to one or more embodiments, the injectors 5 are suitable for atomizing the hydrocarbon feedstock 6 (liquid) and penetrating the catalyst stream.

According to one or more embodiments, the operating conditions of the pipe 1 and/or of the downflow reactor 3 are chosen from the following conditions:
temperature (of reactor outlet) between 520 °C and 750 °C and preferably below 650 °C;
absolute total pressure of between 0.1 MPa and 0.5 MPa;
mass ratio of catalyst 4 to hydrocarbon feedstock 6, C/O, of between 5 (kg/h)/(kg/h) and 35 (kg/h)/(kg/h) and preferably between 15 (kg/h)/(kg/h) and 30 (kg/h)/(kg/h);
contact time t_{c} between the hydrocarbon feedstock 6 and the catalyst of less than 10 seconds, preferably between 0.5 seconds and 4 seconds;
mass flow of catalyst particles of between 50 and 850 kg/(m²s), preferably between 400 and 750 kg/(m²s); and
superficial gas velocity of between 2 m/s and 26 m/s, preferably between 6 m/s and 16 m/s.

In the present description, the contact time to is defined as the product of the solid volume fraction εₛ and the bed height Hₛ (e.g. reactor height L), divided by the superficial gas velocity sgv, this being integrated along the height of the bed, as defined below in the mathematical formula Math 1.

$${t}_{c} = {\int }_{0}^{{H}_{s}} \frac{{ε}_{s} {H}_{s}}{sgv} \qquad Math 1$$

According to one or more embodiments, a quantity of diluent 8 (e.g. nitrogen and/or steam) is added to the feedstock in order to reduce the partial pressure of hydrocarbons in the feedstock, and the diluent is introduced at an amount representing 0% or 0.1% to 40% by weight, preferably 1% to 35% by weight and with preference of between 1% and 30% by weight, relative to the mass of the hydrocarbon feedstock 6.

According to one or more embodiments, at the end of the catalytic cracking step in the downflow reactor 3, the gaseous products and the catalyst, and optionally the unconverted vaporized feedstock, are separated in the gas/solid separator (not shown) containing a dense fluidized bed where the cracking reactions can continue.

According to one or more embodiments, the operating conditions of the separator are chosen from the following conditions:
temperature (of reactor outlet) of between 500 °C and 750 °C, preferably between 550 °C and 700 °C, and even more preferably between 580 °C and 685 °C;
absolute total pressure of between 0.1 MPa and 0.5 MPa and preferably between 0.1 MPa and 0.4 MPa and with preference between 0.1 MPa and 0.3 MPa;
mass ratio of catalyst to feedstock (unconverted vaporized feedstock and gaseous products), C/O, of between 5 (kg/h)/(kg/h) and 40 (kg/h)/(kg/h);
contact time t_{c} between the feedstock and the catalyst of between 500 milliseconds (ms) and 10 seconds; and
partial pressure of the hydrocarbons in the feedstock (PPHfeedstock) of between 0.01 MPa and 0.3 MPa, preferably between 0.02 MPa and 0.2 MPa and with preference between 0.05 MPa and 0.15 MPa.

According to one or more embodiments, at the outlet of the separator, the coked catalyst is sent to an optional stripper (not shown) in order to strip the hydrocarbons that have remained adsorbed on the surface of the catalyst by means of a second diluent.

According to one or more embodiments, the operating conditions of the stripper are chosen from the following conditions:
residence time of the catalyst in the stripper: between 10 seconds and 180 seconds, preferentially between 30 seconds and 120 seconds;
superficial gas velocity between the minimum fluidization velocity and the velocity of transition to the turbulent regime, for example between 0.01 m/s and 0.5 m/s, preferentially between 0.15 m/s and 0.4 m/s;
solid flow between 25 kg/m²s and 200 kg/m²s, preferentially between 50 kg/m²s and 150 kg/m²s and preferably between 50 kg/m²s and 100 kg/m²s;
temperature between 500 °C and 750 °C, preferentially between 550 °C and 650 °C;
absolute total pressure of between 0.1 MPa and 0.5 MPa and preferably between 0.1 MPa and 0.4 MPa and with preference between 0.1 MPa and 0.3 MPa;
solid volume fraction between 0.25 and 0.6, preferentially between 0.4 and 0.6.

According to one or more embodiments, at the outlet of the separator or stripper, the coked solid is transported to a regenerator (not shown) in which an air supply burns the coke off the catalyst to produce hot regenerated catalyst and combustion gases, it being possible for the hot regenerated catalyst to feed the downward flow 4 with hot catalyst particles.

According to one or more embodiments, the operating conditions of the regenerator are chosen from the following conditions:
superficial gas velocity between 0.1 m/s and 2 m/s, preferentially between 0.2 m/s and 1.5 m/s;
residence time of the catalyst between 30 seconds and 20 minutes, preferentially between 1 minute and 10 minutes;
temperature between 500 °C and 840 °C, preferentially between 650 °C and 750 °C.

### EXAMPLES

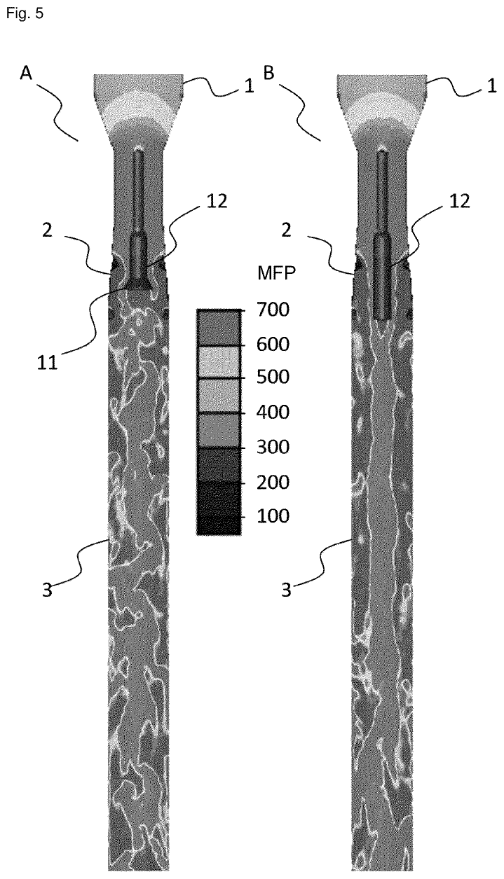

With reference to FIG. 5, the flows in an apparatus according to the invention A and a reference apparatus B operating under non-reaction conditions were compared in order to study the hydrodynamics.

The apparatus according to the invention A and the reference apparatus B comprise:
a pipe 1, composed of a cylindrical portion, a narrowing cone and a cylindrical portion;
a frustoconical mixing chamber 2 (S3/S4 being less than 1) comprising a plug 12 defining an annular zone 13;
a cylindrical downflow reactor 3 having a length of 4.07 m and an internal diameter of 0.42 m, and comprising two rows of 8 obstacles in the form of triangular prisms;
four first injectors 5 for injecting hydrocarbon feedstock 6, positioned countercurrent to the downward flow 3 of catalyst particles with an upward angle of 30° relative to the horizontal, the projection of the first injectors 5 on a horizontal plane being perpendicular to the tangent of the mixing chamber 2;
four second injectors 7 for injecting diluent 8 (steam), positioned countercurrent to the downward flow 3 of catalyst particles with an upward angle of 30° relative to the horizontal, the projection of the second injectors 7 on a horizontal plane forming an angle of 45° with the tangent of the mixing chamber 2, the first injectors 5 and second injectors 7 being positioned in alternating fashion (on a horizontal plane).

The apparatus according to the invention has an annular internal 11 positioned continuously (e.g. in the form of a collar with a triangular cross section with a horizontal base) around the central plug 12.

The reference apparatus B has no internal positioned on the plug 12.

The configurations of the apparatus according to the invention A and of the reference apparatus B were simulated in CFD with the Barracuda© tool under the following operating conditions:
the catalyst flow is 729 kg/m²s;
the catalyst has a diameter d₅₀ of 73 μm and a grain density of 1418 kg/m³ (i.e., group A of the Geldart classification);
the air flow rate of 1.85 kg/s exhibits a ratio of the first injectors 5 to the second injectors 7 of 70/30;
the first injectors 5 are positioned 0.3 m above the upper end of the downflow reactor 3;
the angle of rotation between the first injectors 5 and the second injectors 7 is 45°;
the gas velocity at the outlet of the injectors is 90 m/s for the first injectors 5 and 76 m/s for the second injectors 7;
the flow is under ambient conditions and without reaction;
a plug 12 is positioned at the center of the mixing chamber 2.

FIG. 5 presents the Mass Fraction of Particles, denoted MFP, for the two configurations A and B of the apparatus according to the invention A and of the reference apparatus B, respectively. Advantageously, the radial distribution of the solid along the downflow reactor 3 is always more homogeneous for the apparatus according to the invention A compared to the reference apparatus B. In addition, a high concentration of the solid on the central zone of the downflow reactor 3, and a low concentration of the solid along the wall of the downflow reactor 3, can be noted for the reference apparatus B compared to the apparatus according to the invention A.

1. An apparatus for cocurrent gas-solid downflow fluid catalytic cracking comprising, from top to bottom:
a pipe (1) suitable for transporting a downward flow (4) of catalyst particles;
a mixing chamber (2) connected to the pipe (1) and suitable for being fed by the pipe (1) with downward flow (4), the mixing chamber (2) comprising an internal wall, at least one first injector (5) for injecting hydrocarbon feedstock (6) and a central plug (12) defining an annular zone (13) via which the catalyst particles pass through the mixing chamber (2); and
a cocurrent gas-solid downflow fluidized bed reactor (3) connected to the mixing chamber (2) and suitable for being fed by the mixing chamber (2) with a mixture comprising catalyst particles and hydrocarbon feedstock (6),
in which apparatus the mixing chamber (2) comprises at least one internal (11) on and preferably around the central plug (12) and arranged below the at least one first injector (5) and being suitable for distributing the mixture towards the wall of the mixing chamber (2).

2. The apparatus as claimed in claim 1, wherein the at least one internal (11) is suitable for reducing the passage cross section in the annular zone (13) by 1% to 35%.

3. The apparatus as claimed in claim 1, wherein the at least one internal (11) is suitable for avoiding the accumulation of catalyst particles on said internal (11).

4. The apparatus as claimed in claim 1, wherein the at least one internal (11) comprises an oblique upper surface that descends towards the outside.

5. The apparatus as claimed in claim 4, wherein the oblique upper surface of the at least one internal (11) is straight, convex and/or concave.

6. The apparatus as claimed in claim 4, wherein the oblique upper surface of the at least one internal (11) forms an angle β comprised between 10° and 80°, relative to the horizontal.

7. The apparatus as claimed in claim 1, wherein the at least one internal (11) is arranged on the central plug (12) at an axial distance (L) from the first injectors (5) for injecting hydrocarbon feedstock (6) of between 0*H3 and 1*H3, H3 being the height of the at least one internal (11).

8. The apparatus as claimed in claim 1, wherein the at least one internal (11) is a plurality of internals (11) positioned discontinuously on the central plug (12).

9. The apparatus as claimed in claim 8, wherein the internals (11) are prismatic, cylindrical, pyramidal, conical and/or frustoconical in form.

10. The apparatus as claimed in claim 8, comprising at least one row of internals (11) arranged at a predetermined height on the central plug (12).

11. The apparatus as claimed in claim 10, wherein the perimeter of the wall of the central plug (12) occupied by the row of internals (11) is between 10% and 100%.

12. The apparatus as claimed in claim 10, wherein the row of internals (11) comprises between 1 and 16 internals (11).

13. The apparatus as claimed in claim 1, wherein the at least one internal (11) is annular in form and is positioned continuously on and around the central plug (12).

14. The apparatus as claimed in claim 13, comprising between 1 and 6 rows of internals (11) and/or between 1 and 12 internals (11) of annular form arranged at a predetermined height on the central plug (12).

15. A process for cocurrent gas-solid downflow fluid catalytic cracking, comprising the following steps:
transporting a downward flow (4) of catalyst particles in a pipe (1);
feeding a mixing chamber (2) via the pipe (1) with the downward flow (4), the mixing chamber (2) comprising an internal wall, at least one first injector (5) for injecting hydrocarbon feedstock (6) and a central plug (12) defining an annular zone (13) via which the catalyst particles pass through the mixing chamber (2);
feeding a cocurrent gas-solid downflow fluidized bed reactor (3) via the mixing chamber (2) with a mixture comprising catalyst particles and hydrocarbon feedstock (6); and
at least partially cracking the hydrocarbon feedstock (6) in the presence of the catalyst particles in the cocurrent gas-solid downflow fluidized bed reactor (3), in order to produce an effluent (10) comprising at least partially coked catalyst and gaseous cracking products;
in which the mixing chamber comprises at least one internal (11) arranged below the at least one first injector (5) and being suitable for distributing the mixture towards the wall of the mixing chamber (2).
